(19) United States
(12) Patent Application Publication
(10) Pub. No.: US 2013/0232085 A1
(43) Pub. Date: Sep. 5, 2013

(54) METHOD OF COMPARING TOTAL COST OF TIRE OWNERSHIP

(71) Applicants: John Emerson, Simpsonville, SC (US); Leah Martin, Simpsonville, SC (US)

(72) Inventors: John Emerson, Simpsonville, SC (US); Leah Martin, Simpsonville, SC (US)

(73) Assignees: MICHELIN RECHERCHE ET TECHNIQUE S.A., GRANGES-PACCOT (CH); COMPAGNIE GENERALE DES ETABLISSEMENTS MICHELIN, CLERMONT-FERRAND (FR)

(21) Appl. No.: 13/884,868

(22) PCT Filed: Nov. 11, 2010
(86) PCT No.: PCT/US10/56314

§ 371 Date: May 10, 2013

(51) Int. Cl. G06Q 30/02

(52) U.S. Cl. CPC G06Q 30/0278
USPC 705/306

(57) ABSTRACT

A method of comparing the total cost of ownership between different tires is provided. More particularly, a method for comparing the total cost when certain information, such as selling price, is not available for one of the tires is provided. The method can be used, for example, to determine the amount by which a tire must be discounted to account for performance differences relative to other tires.

### FIELD OF THE INVENTION

The present invention relates to a method of comparing the total cost of ownership between different tires and, more particularly, to comparing the total cost when certain information, such as selling price, is not available for one of the tires.

### BACKGROUND OF THE INVENTION

In a common usage of the term, “total cost of ownership” has been used to refer to an economic analysis of all costs associated with a particular investment. Such total cost of ownership can be used to determine the economic value of the investment. The total cost of ownership can also be used to determine the differences in cost between different investments (e.g., product purchases) in order to provide assistance in selecting between investment choices.

Total cost analysis can also help determine whether there is a significant difference between e.g., the purchase price of a product versus the long term, overall cost associated with the product. Such a difference can be very helpful in ascertaining the true economic value between buying different products. For example, while two different products may have similar prices, the total cost associated with one of the products may be much higher due to e.g., a shorter life span and earlier replacement requirement. Similarly, where two products have different prices, a total cost analysis can be used to help determine which product is a better investment choice so that factors other than just the relative selling prices between different products are considered.

For a tire purchase, the total cost of ownership can include e.g., the cost or purchase price of the tire as well as the cost associated with the use of the tire over its lifetime. The price differences between tires, even those intended for the same application, can vary substantially depending upon the construction quality of the tire. Some tires may e.g., include features that increase the selling price of the tire but also increase the useful life of the tire. In addition, the cost associated with the use of the tire can also vary substantially depending e.g., the fuel efficiency of the tire due to rolling resistance. The intended application for the tire can cause differences in total cost: A tire intended for use on a commercial trailer may wear very differently than a tire used on the drive axles of a tractor. Even tires in the same position, such as the steer tires for a tractor, may see very different wear patterns when used primarily on long haul rather than e.g., regional trips. Accordingly, a comparison of the total costs associated with two different tires can be very dependent upon the particular application for which the tires are intended as well as the construction quality of the tire.

In determining the selling price that can be requested for a particular tire, an analysis of the total cost associated with that tire relative to a competitive tire can be very useful. Where all cost information is available or can be readily determined, such total cost analysis can be provided. For example, retail sales data may be obtained from surveys of the marketplace and performance data may be provided by the tire manufacturer or may be obtained through testing.

However, for certain markets, the selling price of competitive tires may not be available. Some manufacturers may sell directly to the end user in business to business sales for which the pricing information is not public. By way of example, the manufacturer may sell directly to a large volume retailer in a transaction where details include pricing are maintained as confidential. Similarly, fleet operators may purchase tires directly from the manufacturer such that advertising of pricing or other public disclosure of the pricing does not occur. In such cases, the conventional total cost of ownership analysis between a reference tire and a competitive tire cannot be completed because a critical datum of information is missing: the sales price of the competitive product.

Accordingly, a method for comparing the total cost of tire ownership where pricing information is incomplete would be very useful. More particularly, a method that allows comparison of the total costs associated with purchasing different tires where e.g., price information is not available for one of the tires would be beneficial.

### SUMMARY OF THE INVENTION

Aspects and advantages of the invention will be set forth in part in the following description, or may be obvious from the description, or may be learned through practice of the invention.

In one exemplary aspect of the present invention, a method for total tire cost analysis is provided. This exemplary method includes the steps of selecting a reference tire and a test tire for analysis; choosing a usage interval for analysis; calculating TCO_{REF}, the total cost of ownership for the reference tire over the usage interval; providing a hypothetical selling price for the test tire; calculating TCO_{TEST}, the total cost of ownership for the test tire over the usage interval based on the hypothetical selling price; comparing TCO_{TEST} and TCO_{REF} and, if the absolute value of the difference between TUC_{TEST} and TCO_{REF} is greater than a predetermined value, then adjusting the hypothetical selling price for the test tire; and repeating the steps of calculating and comparing until the absolute value of the difference between TCO_{TEST} and TCO_{REF} is equal to, or less than, the predetermined value; and reporting the hypothetical selling price for the test tire at which the absolute value of the difference between TCO_{TEST} and TCO_{REF} is equal to, or less than, the predetermined value.

If desired, an additional step of reporting can be provided wherein the difference between the selling price of the reference tire minus the hypothetical selling price for the test tire is reported when the absolute value of the difference between TCO_{TEST} and TCO_{REF} is equal to, or less than, the predetermined value.

The step of calculating TCO_{REF}, the total cost of ownership for the reference tire over the usage interval, can include obtaining TUC_{REF}, the total usage cost for the reference tire over the usage interval; determining AC_{REF}, the acquisition cost for the reference tire over the usage interval; and adding TUC_{REF}, and AC_{REF} to provide TCO_{REF}, the total costs of ownership of the reference tire.

The step of calculating TCO_{TEST}, the total cost of ownership for the test tire over the usage interval based on the hypothetical selling price, can include obtaining TUC_{TEST}, the total usage cost for the test tire over the usage interval; determining AC_{TEST}, the acquisition cost for the test tire over the usage interval based on the hypothetical selling price; and adding TUC_{TEST}, and AC_{TEST} to provide TCO_{TEST}, the total costs of ownership for the test tire over the usage interval based on the hypothetical selling price.

The step of obtaining TUC_{REF}, the total usage cost for the reference tire over the usage interval, can include determining the values of rolling resistance of the reference tire at full tread depth and at a removal condition for the reference tire; and calculating fuel consumption associated with use of the reference tire over the usage interval, wherein the step of calculating applies the values of rolling resistance for the reference tire at full tread depth and at the removal condition for the reference tire as well as fuel consumption costs over the usage interval. The step of calculating fuel consumption associated with use of the reference tire over the usage interval can include application of one or more of the following variables including: the vehicle type on which the reference tire will be placed, the loading conditions for the position at which the reference tire will be placed on the vehicle, the baseline fuel economy of the vehicle, the annual mileage, and the duration of use. The step of obtaining TUC_{REF}, the total usage cost for the reference tire over the usage interval can further include providing maintenance costs for the reference tire over the usage interval. The step of obtaining TUC_{REF} can also include adding the fuel consumption associated with use of the reference tire over the usage interval to the maintenance costs for the reference tire over the usage interval.

The step of obtaining TUC_{TEST}, the total usage cost for the test tire over the usage interval, can include determining values of rolling resistance of the test tire at full tread depth and at a removal condition for the test tire; and calculating fuel consumption associated with use of the test tire over the usage interval, wherein the step of calculating applies the values of rolling resistance for the test tire at full tread depth and at the removal condition for the test tire as well as fuel consumption costs over the usage interval. The step of calculating fuel consumption associated with use of the test tire over the usage interval can further include application of one or more of the following including: the vehicle type on which the test tire will be placed, the loading conditions for the position at which the test tire will be placed on the vehicle, the baseline fuel economy of the vehicle, the annual mileage, and the duration of use. The step of obtaining TUC_{TEST}, the total usage cost for the test tire over the usage interval can include providing maintenance costs for the test tire over the usage interval. The step of obtaining TUC_{TEST} can further include adding the fuel consumption associated with use of the test tire over the usage interval to the maintenance costs for the test tire over the usage interval.

The step of determining AC_{TEST}, the acquisition cost for the test tire over the usage interval, can include determining the wear life of the test tire; setting AC_{TEST} as the hypothetical selling price for the test tire and, if the wear life of the test tire is less than the usage interval, then adding RPL_{TEST}, the cost of replacing the test tire, to AC_{TEST}. Alternatively, if the wear life of the test tire is greater than the usage interval, then subtracting from AC_{TEST} the value associated with the amount by which the wear life of the test tire exceeds the usage interval. RPL_{TEST}, the cost of replacing the test tire, can be defined as the hypothetical selling price of the test tire pro-rated by an amount of time equal to the usage interval less the wear life of the test tire.

The step of determining AC_{REF}, the acquisition cost for the reference tire over the usage interval, can include determining the wear life of the reference tire; providing a selling price for the reference tire; setting AC_{REF} as selling price for the reference tire and, if the wear life of the reference tire is less than the usage interval, then adding RPL_{REF}, the cost of replacing the reference tire, to AC_{REF}. Alternatively, if the wear life of the reference tire is greater than the usage interval, then subtracting from AC_{REF} the value associated with the amount by which the wear life of the reference tire exceeds the usage interval. RPL_{REF}, the cost of replacing the reference tire, can be defined as the selling price of the reference tire pro-rated by an amount of time equal to the usage interval of the reference tire less the wear life of the reference tire.

This exemplary method may further include the step of determining the amount by which the selling price of the test tire must be discounted relative to the selling price of the reference tire in order to achieve a total cost for the test tire that is equal to the total cost of the reference tire. Alternatively, this exemplary method may also include the step of determining the amount by which the selling price of the test tire may be increased above the selling price of the reference tire in order to achieve a total cost for the test tire that is equal to the total cost of the reference tire.

The usage interval may be defined in a variety of ways. For example, the usage could be defined as one year, a predetermined number of miles such as 100,000 miles, or other intervals as desired for the comparison of total costs between the test tire and reference tire.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a flow chart illustrating steps of an exemplary method of the present invention.

FIG. 2 provides a flow chart illustrating steps of an exemplary method for calculating the total cost of ownership for a reference tire.

FIG. 3 provides a flow chart illustrating steps of an exemplary method for calculating the total cost of ownership for a test tire.

### DETAILED DESCRIPTION OF THE INVENTION

The present invention relates to a method of comparing the total cost of ownership between different tires and, more particularly, to comparing the total cost when complete information, such as the sales prices, is not available for one of the tires. For purposes of describing the invention, reference now will be made in detail to embodiments and/or methods of the invention, one or more examples of which are illustrated in or with the drawings. Each example is provided by way of explanation of the invention, not limitation of the invention. In fact, it will be apparent to those skilled in the art that various modifications and variations can be made in the present invention without departing from the scope or spirit of the invention. For instance, features or steps illustrated or described as part of one embodiment, can be used with another embodiment or steps to yield a still further embodiments or methods. Thus, it is intended that the present invention covers such modifications and variations as come within the scope of the appended claims and their equivalents.

As used herein, the following definitions apply:

“Total cost analysis” refers to a comparison of the costs of investment or purchasing decisions. The analysis does not require inclusion of every conceivable cost, although such may improve accuracy of the comparison.

“Usage interval” is a period of tire use that is selected for the total cost analysis. The usage interval selected can be arbitrary and can be based e.g., on time or distance. By way of example, the usage interval could be selected as one year, 100,000 miles, the lifetime of one of the tires, and other usage intervals may be used as well.

“Reference tire” is the tire for which total cost information is known. For example, the reference tire is the tire for which selling price and performance information is known.

“Test tire” is the tire for which total cost information is incomplete. For example, the test tire is the tire for which the sales price is unknown.

TCO_{REF} is the total cost of ownership for the reference tire over the usage interval.

TCO_{TEST} is the total cost of ownership for the test tire over the usage interval based on a hypothetical selling price.

TUC_{REF} is the total usage cost for the reference tire over the usage interval.

TUC_{TEST} is the total usage cost for the test tire over the usage interval.

AC_{REF} is the acquisition cost for the reference tire over the usage interval.

AC_{TEST} is the acquisition cost for the test tire over the usage interval.

RPL_{REF} is the cost of replacing the reference tire.

RPL_{TEST} is the cost of replacing the test tire.

TIRE_{REF} refers to the reference tire.

TIRE_{TEST} refers to the test tire.

“Wear life” is the expected time or mileage at which removal of the tire from service on the vehicle is expected. For example, legal restrictions may require removal of the tire when the tread depth reaches 2/32 of an inch. However, a customer such as a fleet operator, may require earlier removal such as at a tread depth of 4/32 of an inch. The time or mileage for which removal is required can be predicted, for example, from wear information provided in customer surveys. In this way, the present invention can be customized to the wear life performance experienced by a particular customer. Of course, data from several customers may be used as well.

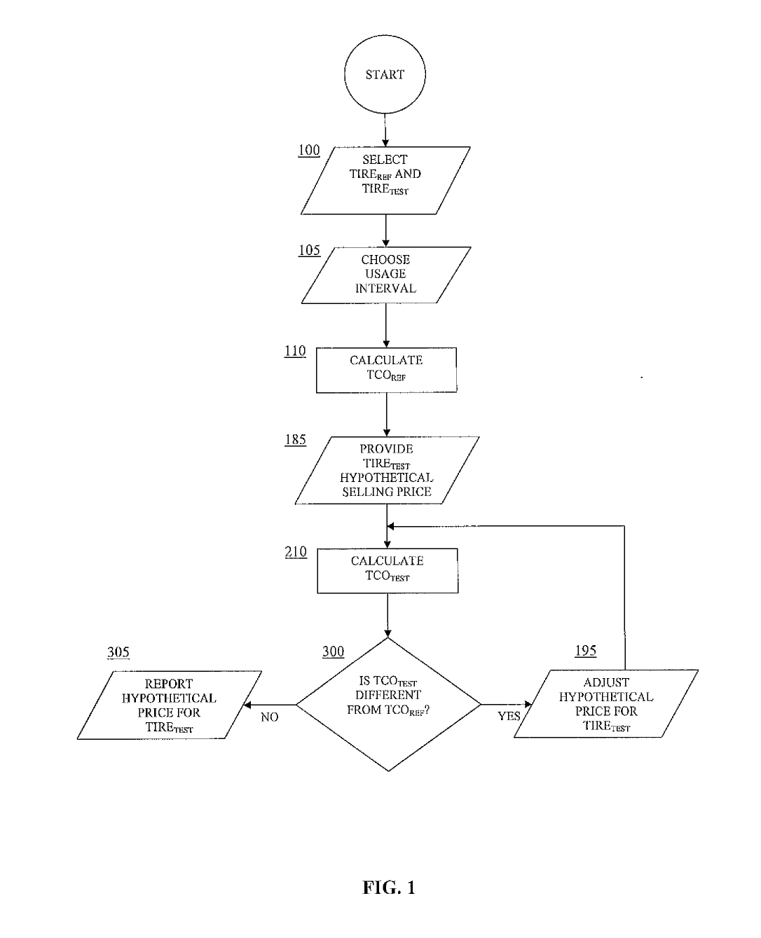

A flowchart in FIG. 1 provides an exemplary method of the present invention for conducting a total cost comparison between a reference tire and a test tire. In step 100, a reference tire and a test tire are selected. The reference tire is one for which the total cost of ownership, including selling price, are known. The test tire is one for which the total costs of ownership are not known because the selling price of the test tire is unavailable.

By way of example, the reference tire and test tire may be products for which performance data are known. Such data may be provided through testing or may be provided by customer survey. One problem facing a manufacturer or seller in such situations is determining what price is reasonable to expect customers will pay for the reference tire, particularly when the selling price of the test tire is unknown. A related challenge is determining what difference in price between the reference tire and test tire will be competitive given certain differences in the total costs of ownership between the tires based on e.g., performance differences between the tires. Accordingly, in step 100, a reference tire and test tire for which a total cost comparison is desired are selected in step 100.

Next, in step 105, a usage interval is selected. The usage interval may be a mileage interval or a period of time. For example, it may be desirable to compare two tires over a period of use of one year. A particular customer may be interested in receiving a total cost analysis based on e.g., a fiscal year of operation. Alternatively, the usage interval may be selected as 100,000 miles, the wear life for the reference tire, or the wear life for the test tire. Again, wear life information may be acquired by testing or customer survey. Other usage intervals may be used as well provided the same usage interval is applied to both the reference tire and the test tire for purposes of the total cost analysis.

The total cost of ownership of the reference tire over the usage interval, TCO_{REF}, is calculated in step 110. Ideally, TCO_{REF} would include all costs of ownership associated with the reference tire as complete information can increase the accuracy of the comparison with the test tire—provided the same information, with the exception of e.g., price, is available for the test tire. Alternatively, TCO_{REF} may be defined to include a subset of the total costs or expenses of ownership depending upon what information is available for the tires being compared.

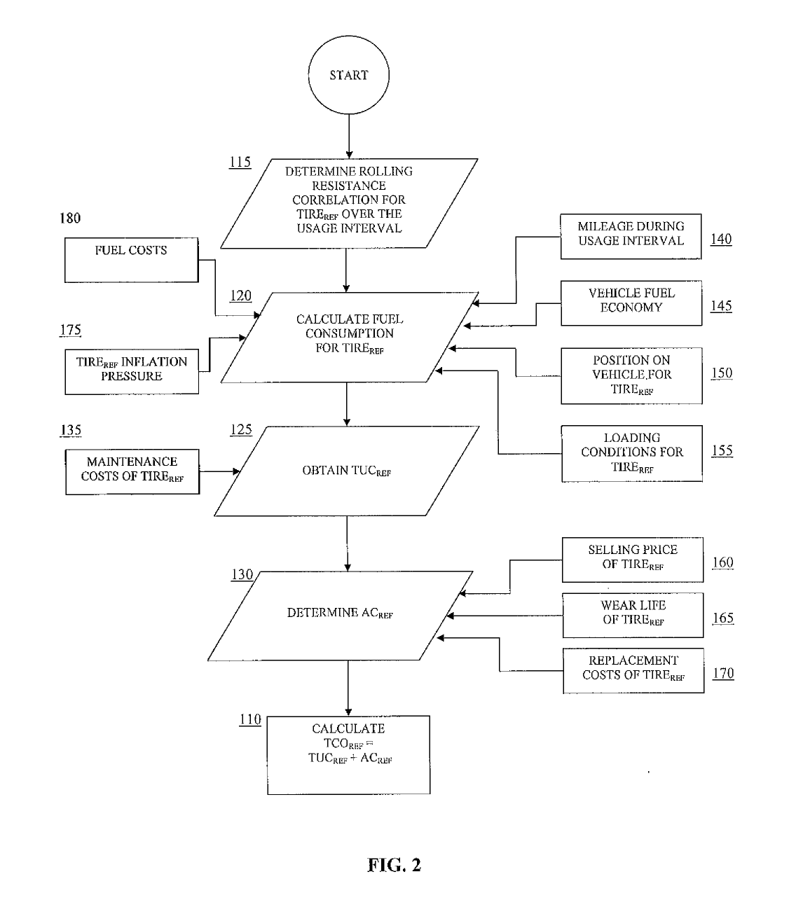

For purposes of this exemplary embodiment of the present invention, FIG. 2 provides a flow chart with an example of steps as may be used in calculating TCO_{REF}. In step 110, TCO_{REF} is defined as the sum of the acquisition costs for the reference tire over the selected usage interval, AC_{REF}, and the total usage cost for the reference tire over the usage interval TUC_{REF}. This is also expressed mathematically in equation 1 as:

TCO_{REF}=AC_{REF}TUC_{REF} (1)

The total usage costs for the reference tire includes several different costs. One such cost is the fuel consumption attributable to the reference tire, which is determined in step 120. A tire is responsible for energy loss, and therefore fuel consumption, because of the tire's rolling resistance. Such rolling resistance is due to the nature of deformable materials that are used in the tire's construction. In general, during operation, energy used in the deformation of the tire is not fully recovered and, instead, is lost in conversion to other forms such as heat.

The amount of such rolling resistance can be quantified into an energy unit per distance value. Several standardized procedures exist for measuring the rolling resistance of a tire such as SAE J1290 and SAE J1270. Rolling resistance varies as a function of several factors. One such factor is tread depth. Accordingly, measurements of rolling resistance can be conducted at various points during the life of the tire with, e.g., interpolation between such points based on mileage. By way of example, one method includes measuring the rolling resistance at full tread depth and then at the removal condition at which the tire will be taken out of use, which will typically be at the end of its wear life but other removal conditions may be used as well.

Other factors that impact the amount of rolling resistance include the tire inflation pressure 175 and the loading conditions for the tire—i.e. the amount of weight on the tire during use 155. This information can be provided, for example, by determining the average weight on the reference tire during the usage interval and the duration over the usage interval for which the tire bears such weight. The position of the tire on the vehicle 150, such as the position on a trailer, can impact rolling resistance by impacting e.g., the rate of tread wear over the usage interval. As will be understood by one of skill in the art, correlation models can be developed that relate the impact of these various factors on rolling resistance so as to provide for determining the amount of energy, i.e. fuel consumption, per unit of distance that is attributable to rolling resistance. Then, using economy information for the vehicle 145, the costs of fuel 180, and the distance amount (e.g., mileage) during the usage interval 140, the total amount of fuel consumption attributable to the reference tire over the usage interval can be calculated as in step 120.

Another factor that impacts the total usage cost over the usage interval, TUC_{REF}, is the maintenance cost 135 of the reference tire over the usage interval. Maintenance cost can include e.g., inflation checks, tire balancing, tire rotation, and other maintenance expense as well. Again, these values may be provided e.g., by customer surveys based on use of the reference tire. The survey data for maintenance cost can be prorated, if necessary, so as to match the interval for which the maintenance costs were recorded with the usage interval selected in step 105.

In step 130, the sum of the acquisition costs for the reference tire over the selected usage interval, AC_{REF}, is determined. For the reference tire, AC_{REF} includes the selling price 160 of the tire plus its replacement cost 170 over the usage interval. For example, suppose the usage interval is selected as 100,000 miles and the reference tire has a wear life 165 of 80,000 miles. In such case, AC_{REF} will include the selling price of the reference tire plus the prorated costs of a replacement reference tire e.g., 2/10 of a replacement tire selling price. Other situations affecting the acquisition cost can be accounted for as well. For example, if the worn reference tire has a value at the end of its wear life such as a resale value for tire retreading, this amount can be subtracted to reduce the overall amount of AC_{REF}. If the reference tire still has additional wear life at the end of the usage interval, the value of this remaining life can be deducted from AC_{REF} on e.g., a pro-rata basis.

Returning to step 110 and equation 1, once the acquisition costs for the reference tire over the selected usage interval, AC_{REF} is determined and the total usage cost for the reference tire over the usage interval TUC_{REF} is determined, these two addends are added together to provide TCO_{REF} the total costs of ownership of the reference tire over the usage interval.

Referencing now FIG. 1, in step 185 a hypothetical selling price is provided for the test tire. More specifically, for this exemplary method of the present invention, the actual selling price of the test tire is information that is not available. Accordingly, a hypothetical selling price is provided for the test tire is created. By way of example, this hypothetical price can be a guess or can be set at the known selling price of the reference tire simply to provide a starting point for the total cost comparison.

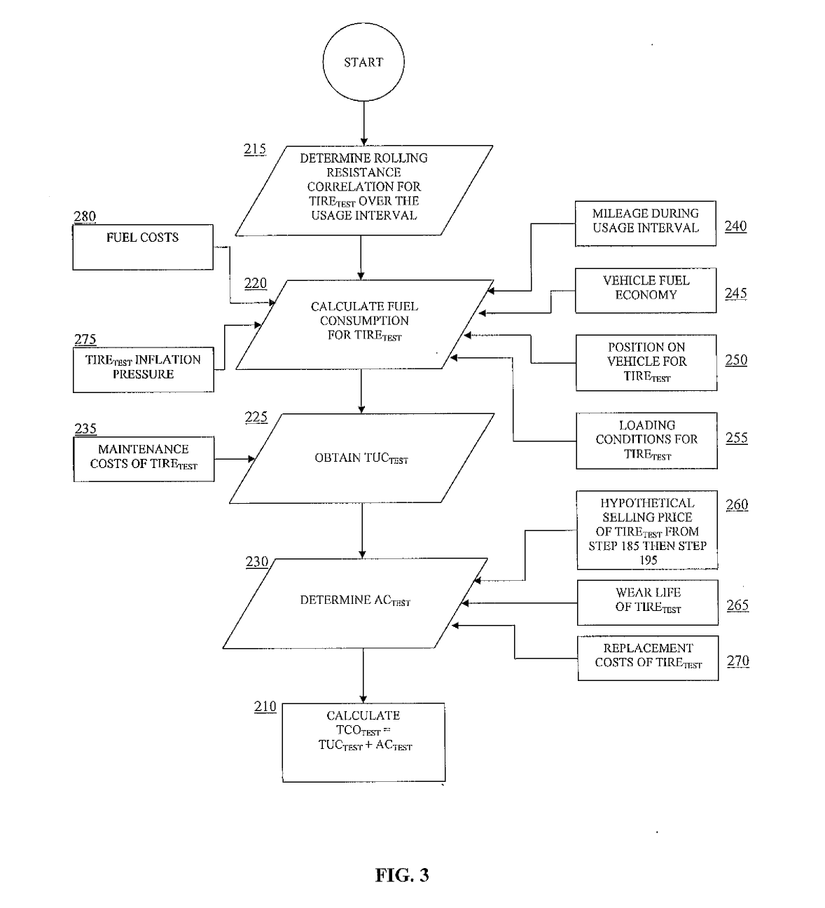

In step 210, the total cost of ownership for the test tire over the usage interval, TCO_{TEST}, is calculated using the hypothetical selling price. FIG. 3 provides a flow chart illustrating the steps that are to calculate TCO_{TEST} for the test tire. With the exception of step 260, the description of the method for calculating TCO_{TEST} is similar to the steps that are shown in FIG. 2 for calculating TCO_{REF} for the reference tire. Accordingly, similar reference numerals are used in FIG. 3 to identify similar or identical input or steps as in FIG. 2. For example, the mileage during the usage interval 240, the vehicle fuel economy 245, the position on the vehicle for the test tire 250, and the loading conditions for the test tire 255 will likely be identical information as in used in FIG. 2. On the other hand, the rolling resistance correlation 215 and the wear life of the tire 265 are likely to have different values based on differences between the test tire and the reference tire.

In step 260, the hypothetical selling price from step 185 is used to determine the acquisition costs AC_{TEST} for the test tire. Thus, AC_{TEST} includes the hypothetical selling price of the tire plus its replacement cost over the usage interval. For example, suppose the usage interval is selected as 100,000 miles and the test tire has a wear life of 60,000 miles. In such case, AC_{TEST} will include the selling price of the reference tire plus the pro-rated costs of a replacement test tire e.g., 4/10 of a replacement tire selling price. Other situations affecting the acquisition cost can be accounted for as well. For example, if the worn test tire has a value at the end of its wear life such as a resale value for tire retreading, this amount can be added to reduce the overall amount of AC_{TEST}. If the test tire still has additional wear life at the end of the usage interval, the value of this remaining life can be deducted from AC_{TEST} on e.g., a pro-rata basis.

Accordingly, in step 210, TCO_{TEST} is calculated as the sum of the acquisition costs for the test tire over the selected usage interval, AC_{TEST}, and the total usage cost for the test tire over the usage interval TUC_{TEST}. This is also expressed mathematically in equation 2 as:

TCO_{TEST}=ACₜₑₛₜ+TUC_{TEST} (2)

Returning now to FIG. 1, in step 300 the value of TCO_{TEST} and the value of TCO_{REF} are compared. If the two values are the not different, then in step 305 the hypothetical selling price used to calculate TCO_{TEST} is reported. If the two values are different, then in step 195 the hypothetical selling price for the test tire is adjusted. For example, if TUC_{TEST} is larger than TCO_{REF}, then the hypothetical selling price for the test tire is reduced. Alternatively, if TCO_{TEST} is smaller than TCO_{REF}, then the hypothetical selling price for the test tire is increased.

Now, using the adjusted hypothetical selling price for the test tire from step 195, the calculation of TCO_{TEST} in step 210 is repeated, and the value of TCO_{TEST} and the value of TCO_{REF} are compared again in step 300. If the two values TCO_{TEST} and TCO_{REF} are not different, then in step 305 the hypothetical selling price used to calculate TCO_{TEST} is reported. If the two values are different, then in step 195 the hypothetical selling price for the test tire is again adjusted and the iteration of steps 210, 300, and step 195 are repeated until TCO_{TEST} and TCO_{REF} are not different. It should be understood that “not different” as used herein does not require that TCO_{TEST} and TCO_{REF} are strictly mathematically equal.

Once a hypothetical selling price for the test tire is reached at which TCO_{TEST} and TCO_{REF} are no longer different, the seller of the reference tire is provided with useful information that can be used e.g., in advertising, promotions, and/or in adjusting the selling price of the reference tire. For example, when TCO_{TEST} and TCO_{REF} are about the same, assume that the hypothetical selling price of the reference tire is less than the actual selling price of the reference tire. In such case, the difference between TCO_{TEST} and TCO_{REF} provides the amount by which the actual selling price of the test tire (unknown at this point) must be discounted relative to the selling price of the reference tire in order for the total costs of the tires to be about the same. This is defined in equation 3 below as the theoretical discount for the test tire.

THEORETICAL_{DISC-TEST}=SELLING PRICE of TIRE_{REF}−HYPOTHETICAL SELLING PRICE of TIRE_{TEST} (3)

As stated, when THEORETICAL_{DISC-TEST} is a positive number, is represents the amount by which the test tire should be reduced below the selling price of the reference tire to compensate for performance disadvantages of the test tire. Alternatively, where THEORETICAL_{DISC-TEST is a negative number, it represents the amount by which the test tire can have a higher price than the reference tire to compensate for performance advantages of the test tire.}

The purchasing decision buyers make typically will include a lot of factors, of which the total cost may be just one part. In such case, THEORETICAL_{DISC-TEST} may need to be adjusted to reflect the sellable discount, which is the price adjustment perceived as necessary by the customer to compensate for performance differences. For example, even though the reference tire might have an improved acquisition cost, consumers may only be willing to pay for 50 percent of the value of such improvement. Similarly, even though the reference tire may have improved maintenance costs, consumers may only be willing to pay for 25 percent of the value of such improvement. As such, the THEORETICAL_{DISC-TEST} may need to be adjusted to reflect the sellable discount that can be actually realized in the market.

In the exemplary method set forth above, the selling price of the test tire was treated as the information that was unavailable to the total cost comparison. However, using the teachings disclosed herein, one of skill in the art will understand that the present invention may be applied in a similar manner to determine e.g., the hypothetical value of other factors when the selling price of the test tire is known. By way of example, if the selling price of the test tire is known, the present invention could be used to determine the hypothetical value of rolling resistance that the test tire must have in order to have a total cost that is not different from the reference tire. Other hypothetical values may be determined as well.

Table 1 below provides an example application of the present invention as used to determine the hypothetical selling price of a test tire when the selling price of the reference tire is known (or otherwise provided) and performance data for both the reference tire and the test tire are available. The example was based on a usage interval of five years with 120,000 miles of travel per year. A commercial vehicle was used having a total of eighteen wheels between a tractor trailer combination that includes two wheels on the steer axle, eight wheels on the drive axles, and eight wheels on the trailer axles. For this example, the comparison of total costs is between using two test tires on the steer axle and then two reference tires on the steer axle. The remaining sixteen tires were also included in the total costs calculation and were all treated as identical tires for the calculation of total costs. In addition, for simplicity, it was assumed that the test tire and reference tire did not have maintenance costs, salvage values, or retreading expenses. A value of $2.95 per gallon of diesel fuel was also used.

As shown in Table 2, the reference tire was normalized to a tread wear value of 100 while the test tire had a 9 percent less value for tread wear or 91. Similarly, the rolling resistance value for the reference tire in a new condition was normalized at 100 while for the test tire the rolling resistance was 5 percent less or 95. At the end of life, the normalized rolling resistance value for the reference tire was 100 while the test tire was also 100. As shown in Table 1, the hypothetical selling price of the test tire is known or provided at $301. This resulted in a TCO_{REF} (total cost of ownership for the reference tire over the usage interval) for all eighteen tires of $82860 or $13.81 per every 100 miles.

Accordingly, for a first iteration, the hypothetical selling price of the test tire was set at $278 per tire. This resulted in a TCO_{TEST} (total cost of ownership for the test tire over the usage interval) for all eighteen tires of $83244. Thus, at the test tire price of $278 per tire, the difference in total costs for the vehicle over the usage interval when using two reference tires on the steer axle versus two test tires on the steer axle (ΔTCO) is $384. Per tire, this represents 4.17 percent of the total costs of ownership of the reference tire over the usage interval (i.e. the PCT of TCO_{REF}), which can be calculated using equation 4 as

PCT of TCO_{REF}=ABSOLUTE VALUE of ((ΔTCO/2)/(TCO_{REF}/18)) (4)

For iterations two through six, the hypothetical selling price of the test tire was reduced until there was no difference between TCO_{TEST} and TCO_{REF}, which occurred at a hypothetical selling price of $231.50 for the test tire. Accordingly, due to performance differences between the test tire and the reference tire, the price of the test tire should be discounted at least $69.50 relative to the reference tire. However, the actual sellable discount may be some lesser amount as explained above.

As referenced earlier, the present invention does not require iteration until the absolute value of the difference between TCO_{TEST} and TCO_{REF} is zero. Instead, some predetermined value for this difference may be used that is not necessarily zero and that is otherwise determined to be sufficient for the analysis. Accordingly, iteration can continue until the absolute value of the difference between TCO_{TEST} and TCO_{REF} is less than this predetermined value rather than requiring TCO_{TEST} and TCO_{REF} to be equal. Using the teachings disclosed herein, one of ordinary skill in the art will understand that multiple values for the amount of such predetermined value may be used and/or multiple different techniques may be used for selecting such predetermined value.

By way of example, iteration may be continued until the value for PCT of TCO_{REF} (defined above in equation 4) is less than e.g., two percent. As shown in Table 1, when PCT of TCO_{REF} is less than 2 percent, the hypothetical selling price of the test tire is within $25 of the hypothetical selling price at which the difference between TCO_{TEST} and TCO_{REF} is zero. In still other example, iteration may continue until the absolute value of the difference between TCO_{TEST} and TCO_{REF} is less than ten percent of TCO_{REF} or less than ten percent of the selling price of the reference tire. Other values may be used as well.

Once a hypothetical selling price for the test is reached at which TCO_{TEST} and TCO_{REF} are either equal or their difference is less than a predetermined amount, it may be useful to report the difference between such hypothetical selling price of the test tire and the selling price used for the reference tire. The amount of this difference may be more meaningful or understandable to the seller or buyer than simply examining the total costs of the reference tire and test tire. More particularly, it is believed that buyers and sellers intuitively have a better understanding of difference in price than total costs.

Finally, the above description has been premised on an assumption that the actual selling price of the test tire is not available. However, the present invention provides a valuable analysis tool even when the actual selling price of the test tire is available. More specifically, the present invention can be used to calculate a hypothetical selling price of the test tire at which TCO_{TEST} and TCO_{REF} are either equal (or their difference is less than a predetermined value). This hypothetical selling price for the test tire can then be compared to the actual selling of the test tire to determine by what amount the actual selling price is over or under the hypothetical selling price for the test tire. For example, if the actual selling price of the test tire is $250 but its hypothetical selling price for a TCO_{TEST} that is equal to TCO_{IF} is $200, then the actual selling price of the test tire is $50 more than what it should be in order to have a total cost that is the same as the reference tire.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

TABLE 1

| | | | TCO_{REF} | | | TCO_{TEST} | | |
|---|---|---|---|---|---|---|---|---|
| | | | ($) | | | ($) | | |
| | | | for the | Hypothetical | | for the | | |
| | | TCO | vehicle | Selling Price | TCO_{TEST} | vehicle (18 | | PCT of |
| Iteration | Tire | ($/100mi) | (18 tires) | ($) | ($/100mi) | tires) | ΔTCO | TCO_{REF} |
| REF | REF | 13.81 | 82860 | 301.00 | | | | |
| 1 | TEST | | | 278.00 | 13.87 | 83244 | 384 | 4.17 |
| 2 | TEST | | | 255.75 | 13.84 | 83060 | 200 | 2.17 |
| 3 | TEST | | | 243.60 | 13.83 | 82960 | 100 | 1.09 |
| 4 | TEST | | | 229.15 | 13.81 | 82840 | −20 | −0.22 |
| 5 | TEST | | | 230.40 | 13.81 | 82850 | −10 | −0.11 |
| 6 | TEST | | | 231.50 | 13.81 | 82860 | 0 | 0.00 |

TABLE 2

| | Inputs | | | | Outputs | | |
|---|---|---|---|---|---|---|---|
| | | Rolling | | | Acquisition Cost | | |
| | | Resistance | Rolling Resistance | | for the Usage | Usage Cost for the Usage | Total Cost for the |
| | Wear | (New Tire) | (End of Life) | Price | Interval ($) | Interval ($) | Usage Interval ($) |
| REF | 100 | 100 | 100 | 301.00 | 12420 | 70440 | 82860 |
| TEST | 91 | 95 | 100 | 231.50 | 12060 | 70800 | 82860 |

What is claimed is:

1. A method for total tire cost analysis, comprising the steps of:
selecting a reference tire and a test tire for analysis;
choosing a usage interval for analysis;
calculating TCO_{REF}, the total cost of ownership for the reference tire over the usage interval;
providing a hypothetical selling price for the test tire;
calculating TCO_{TEST}, the total cost of ownership for the test tire over the usage interval based on the hypothetical selling price;
comparing TCO_{TEST} and TCO_{REF} and, if the absolute value of the difference between TCO_{TEST} and TCO_{REF} is greater than a predetermined value, then
adjusting the hypothetical selling price for the test tire; and
repeating said steps of calculating and comparing until the absolute value of the difference between TCO_{TEST} and TCO_{REF} is equal to, or less than, the predetermined value; and
reporting the hypothetical selling price for the test tire at which the absolute value of the difference between TCO_{TEST} and TCO_{REF} is equal to, or less than, the predetermined value.

2. A method for total tire cost analysis as in claim 1, wherein said step of calculating TCO_{REF}, the total cost of ownership for the reference tire over the usage interval, comprises:
obtaining TUC_{REF}, the total usage cost for the reference tire over the usage interval;
determining AC_{REF}, the acquisition cost for the reference tire over the usage interval; and
adding TUC_{REF}, and AC_{REF} to provide TCO_{REF}, the total costs of ownership of the reference tire.

3. A method for total tire cost analysis as in claim 2, wherein said step of calculating TCO_{TEST}, the total cost of ownership for the test tire over the usage interval based on the hypothetical selling price, comprises:
obtaining TUC_{TEST}, the total usage cost for the test tire over the usage interval;
determining AC_{TEST}, the acquisition cost for the test tire over the usage interval based on the hypothetical selling price; and
adding TUC_{TEST}, and AC_{TEST} to provide TCO_{TEST}, the total costs of ownership for the test tire over the usage interval based on the hypothetical selling price.

4. A method for total tire cost analysis as in claim 3, wherein said step of obtaining TUC_{REF}, the total usage cost for the reference tire over the usage interval, comprises:
determining the values of rolling resistance of the reference tire at full tread depth and at a removal condition for the reference tire; and
calculating fuel consumption associated with use of the reference tire over the usage interval, wherein said step of calculating applies the values of rolling resistance for the reference tire at full tread depth and at the removal condition for the reference tire as well as fuel consumption costs over the usage interval.

5. A method for total tire cost analysis as in claim 4, wherein said step of calculating fuel consumption associated with use of the reference tire over the usage interval further applies one or more of the following variables including: the vehicle type on which the reference tire will be placed, the loading conditions for the position at which the reference tire will be placed on the vehicle, the baseline fuel economy of the vehicle, the annual mileage, and the duration of use.

6. A method for total tire cost analysis as in claim 4, wherein said step of obtaining TUC_{REF}, the total usage cost for the reference tire over the usage interval, further comprises providing maintenance costs for the reference tire over the usage interval.

7. A method for total tire cost analysis as in claim 6, wherein said step of obtaining TUC_{REF}, the total usage cost for the reference tire over the usage interval, further comprises adding the fuel consumption associated with use of the reference tire over the usage interval to the maintenance costs for the reference tire over the usage interval.

8. A method for total tire cost analysis as in claim 7, wherein said step of obtaining TUC_{TEST}, the total usage cost for the test tire over the usage interval, comprises:
determining values of rolling resistance of the test tire at full tread depth and at a removal condition for the test tire; and
calculating fuel consumption associated with use of the test tire over the usage interval, wherein said step of calculating applies the values of rolling resistance for the test tire at full tread depth and at the removal condition for the test tire as well as fuel consumption costs over the usage interval.

9. A method for total tire cost analysis as in claim 8, wherein said step of calculating fuel consumption associated with use of the test tire over the usage interval further applies one or more of the following including: the vehicle type on which the test tire will be placed, the loading conditions for the position at which the test tire will be placed on the vehicle, the baseline fuel economy of the vehicle, the annual mileage, and the duration of use.

10. A method for total tire cost analysis as in claim 8, wherein said step of obtaining TUC_{TEST,the} total usage cost for the test tire over the usage interval, further comprises providing maintenance costs for the test tire over the usage interval.

11. A method for total tire cost analysis as in claim 10, wherein said step of obtaining TUC_{TEST}, the total usage cost for the test tire over the usage interval, further comprises adding the fuel consumption associated with use of the test tire over the usage interval to the maintenance costs for the test tire over the usage interval.

12. A method for total tire cost analysis as in claim 3, wherein said step of determining AC_{TEST}, the acquisition cost for the test tire over the usage interval, comprises:
determining the wear life of the test tire;
setting AC_{TEST} as the hypothetical selling price for the test tire and,
if the wear life of the test tire is less than the usage interval, then adding RPL_{TEST}, the cost of replacing the test tire, to AC_{TEST}; or
if the wear life of the test tire is greater than the usage interval, then subtracting from AC_{TEST} the value associated with the amount by which the wear life of the test tire exceeds the usage interval.

13. A method for total tire cost analysis as in claim 12, wherein RPL_{TEST}, the cost of replacing the test tire, is equal to the hypothetical selling price of the test tire pro-rated by an amount of time equal to the usage interval less the wear life of the test tire.

14. A method for total tire cost analysis as in claim 2, wherein said step of determining AC_{REF}, the acquisition cost for the reference tire over the usage interval, comprises:
determining the wear life of the reference tire;
providing a selling price for the reference tire;
setting AC_{REF} as selling price for the reference tire and,
if the wear life of the reference tire is less than the usage interval, then adding RPL_{REF}, the cost of replacing the reference tire, to AC_{REF}; or
if the wear life of the reference tire is greater than the usage interval, then subtracting from AC_{REF} the value associated with the amount by which the wear life of the reference tire exceeds the usage interval.

15. A method for total tire cost analysis as in claim 14, wherein RPL_{REF}, the cost of replacing the reference tire, is equal to the selling price of the reference tire pro-rated by an amount of time equal to the usage interval of the reference tire less the wear life of the reference tire.

16. A method for total tire cost analysis as in claim 1, further comprising the step of determining the amount by which the selling price of the test tire must be discounted relative to the selling price of the reference tire in order to achieve a total cost for the test tire that is equal to the total cost of the reference tire.

17. A method for total tire cost analysis as in claim 1, further comprising the step of determining the amount by which the selling price of the test tire may be increased above the selling price of the reference tire in order to achieve a total cost for the test tire that is equal to the total cost of the reference tire.

18. A method for total tire cost analysis as in claim 1, wherein the usage interval is for one year, a predetermined number of miles, or both.

19. A method for total tire cost analysis as in claim 1, further comprising the step of reporting the difference between the selling price of the reference tire minus the hypothetical selling price for the test tire when the absolute value of the difference between TCO_{TEST} and TCO_{REF} is equal to, or less than, the predetermined value.

20. A method for total tire cost analysis as in claim 1, wherein the predetermined value is selected such that PCT of TCO_{REF} is less than two percent.
